(19) United States
(12) Patent Application Publication
(10) Pub. No.: US 2010/0199957 A1
(43) Pub. Date: Aug. 12, 2010

(54) HIGH-PRESSURE EGR APPARATUS

(75) Inventors: Akira Furukawa, Kariya-city (JP); Osamu Shimane, Kariya-city (JP); Shinsuke Miyazaki, Chiryu-city (JP); Yuichiro Moritani, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/700,795

(22) Filed: Feb. 5, 2010

(30) Foreign Application Priority Data
Feb. 6, 2009 (JP) 2009-026299

(51) Int. Cl. F02M 25/07; F02B 47/08

(52) U.S. Cl. 123/568.12; 123/568.21

(57) ABSTRACT

An EGR control valve is driven by an actuator so as to control EGR amount by changing its opening degree. An EGR cooling device is provided in an EGR passage for cooling down EGR gas. A bypass passage is provided to the EGR passage, so that EGR gas may bypass the EGR cooling device. A switching valve is provided in the EGR passage for switching EGR mode from a hot EGR mode in which the EGR gas flows through the bypass passage to a cold EGR mode in which the EGR gas flows through the EGR cooling device, or vice versa. A converting mechanism is provided between the EGR control valve and the switching valve, so that the switching valve is driven by the actuator from its hot to cold switching position (or vice versa) when the EGR control valve is driven by the same actuator in a small angular range.

### CROSS REFERENCE TO RELATED APPLICATION

This application is based on Japanese Patent Application No. 2009-026299 filed on Feb. 6, 2009, the disclosure of which is incorporated herein by reference.

### FIELD OF THE INVENTION

The present invention relates to a high pressure EGR apparatus for re-circulating a part of exhaust gas, which is discharged from an engine to an exhaust gas passage, into intake-air passage as EGR gas. In particular, the present invention relates to a valve operating mechanism for the EGR apparatus, according to which a high pressure EGR control valve for controlling EGR amount as well as a switching valve for switching EGR mode from hot EGR mode to cold EGR mode (and vice versa) is operated.

### BACKGROUND OF THE INVENTION

A high pressure EGR apparatus is generally called as an EGR apparatus, for example, as shown in FIG. 10 (showing a related art), according to which a part of exhaust gas is re-circulated as EGR gas into an intake-air passage at a downstream side of a throttle valve 26, at which negative pressure is generated. As a result, the EGR gas is mixed as un-combustible gas to intake air, so as to suppress an increase of combustion temperature in an engine combustion chamber, so that generation of nitrogen oxides (NOx) may be effectively suppressed. In a high pressure EGR passage 3 in FIG. 10 for re-circulating the EGR gas into an air-intake side, a high pressure EGR control valve 4 is provided for controlling amount the EGR gas by adjusting an opening degree of the EGR passage 3. The opening degree of the EGR passage 3 by the valve 4 is controlled by ECU (Engine Control Unit) depending on operating conditions of the engine (such as, engine rotational speed, engine load, and so on).

As the EGR gas to be re-circulated into the air-intake side is the part of the exhaust gas, which is generated as combustion of fuel, temperature of the EGR gas is high. Therefore, when the EGR gas is re-circulated into the air-intake side, air-intake efficiency of the engine may be decreased due to cubic expansion of the intake air and thereby engine output may be correspondingly decreased.

Therefore, in a prior art EGR apparatus, a high pressure EGR cooling device is provided in the high pressure EGR passage in order to cool down the EGR gas, so that decrease of the engine output may be suppressed on one hand and generation of the nitrogen oxides (NOx) may be effectively suppressed on the other hand.

In the case that the high pressure EGR cooling device is provided in the high pressure EGR passage, the EGR gas to be re-circulated into the engine is always cooled down. As a result, in a warming-up operation after engine operation starts, which is particularly required in a cold district, warming-up effect by the EGR gas may be reduced when the EGR gas is cooled down by the high pressure EGR cooling device.

Namely, the warming-up operation for the engine may be facilitated on one hand by re-circulating the EGR gas of the high temperature into the air-intake side, but on the other hand the sufficient warming-up effect may not be obtained if the high pressure EGR cooling device is provided, because the EGR gas is always cooled down by such high pressure EGR cooling device. As a result, a period for the warming-up operation in a cold temperature condition may be prolonged, ignitionability may be decreased, and a period for generating white smoke may become longer.

Under the above situation, a technology for overcoming the drawback is proposed in the art, for example, as disclosed in Japanese Patent publication No. 2005-098278, according to which a high pressure bypass passage is provided for re-circulating the EGR gas into the air-intake side by bypassing the high pressure EGR cooling device, and a switching valve is provided for selectively opening one of the passage for the high pressure EGR cooling device and the bypass passage and closing the other passage.

According to the prior art, the bypass passage is opened and the passage for the EGR cooling device is closed in the warming-up operation for the engine, in which the warming-up effect by the EGR gas is expected. Therefore, the temperature of the EGR gas is maintained at high temperature.

On the other hand, in the case that possible cubic expansion of the intake air may occur due to the high temperature EGR gas and thereby the engine output may be decreased, the passage for the EGR cooling device is opened and the bypass passage is closed in order that the temperature of the EGR gas is decreased.

As above, it is known in the art that the switching valve for switching over EGR operating mode (EGR through the EGR cooling device or EGR bypassing the EGR cooling device) is provided in addition to the EGR control valve for controlling the EGR amount.

An opening degree of the EGR control valve is controlled depending on the engine rotational speed, the engine load, and so on, so as to obtain the required EGR amount. On the other hand, the switching valve is switched over depending on the warming-up condition of the engine.

Therefore, as each of the EGR control valve and the switching valve should be operated depending on the different operating conditions of the engine, those valves are independently operated from each other.

As a result, independent actuators for driving the EGR control valve and the switching valve are necessary, which would result in the cost-up, size-increase, and weight-increase.

Therefore, there is a demand for driving both of the EGR control valve and the switching valve with one actuator (Please refer to the Japanese Patent Publications No. 2007-132305 and No. 2007-092664).

In the case that both of the EGR control valve and the switching valve are operated by one actuator, they are generally driven at the same time. As a result, each characteristic feature necessary for the respective EGR control valve and switching valve may not be obtained.

Due to the above reasons, the actuator for driving the EGR control valve and the actuator for driving the switching valve are independently provided, even when such structure may cause the cost-up, size-increase, and weight-increase.

### SUMMARY OF THE INVENTION

The present invention is made in view of the above problems. It is an object of the present invention to provide a high pressure EGR apparatus, according to which it is possible with one actuator not only to control both of a high pressure EGR control valve and a switching valve, but also to meet both of characteristic feature required for the high pressure EGR control valve and the characteristic feature required for the switching valve.

According to a feature of the present invention, a high pressure EGR apparatus for an engine comprises;
a high pressure EGR passage for re-circulating a part of exhaust gas from the engine into an air-intake side of the engine as EGR gas;
a high pressure EGR control valve provided in the high pressure EGR passage for controlling EGR gas amount by adjusting an opening degree of the high pressure EGR control valve;
a high pressure EGR cooling device provided in a passage portion of the high pressure EGR passage for cooling down the EGR gas to be re-circulated into the air-intake side;
a bypass passage provided to the high pressure EGR passage in such a manner that the EGR gas to be re-circulated into the air-intake side bypasses the high pressure EGR cooling device;
a switching valve provided in the high pressure EGR passage for switching over an EGR gas flow so that the EGR gas flows either through the high pressure EGR cooling device or through the bypass passage;
an actuator for driving the high pressure EGR control valve; and
a link device having a converting mechanism for converting an output characteristic of the actuator, wherein the link device drives the switching valve by an output converted through the converting mechanism.

In the high pressure EGR apparatus according to the above feature, the high pressure EGR control valve is operated by the actuator, an operational feature (the output characteristic) for operating the high pressure EGR control valve is converted by the converting mechanism, and the switching valve is operated by such converted operational feature.

As a result, it is possible with one actuator,

(a) to change the switching position of the switching valve from a hot switching position (in which the passage portion for the high pressure EGR cooling device is closed, while the bypass passage is opened) to a cold switching position (in which the passage portion for the high pressure EGR cooling device is opened, while the bypass passage is closed), or vice versa, and
(b) to control the EGR amount by moving (rotating) the high pressure EGR control valve, while keeping the switching valve at its hot or cold switching position.

In other words, it is possible with one actuator to control both of the high pressure EGR control valve and the switching valve, and to meet both of the characteristic feature required for the high pressure EGR control valve and the characteristic feature required for the switching valve.

Accordingly, it is possible to suppress a possible increase of the cost for the high pressure EGR apparatus and also to realize a small-sized and light-weight EGR apparatus.

### BRIEF DESCRIPTION OF THE DRAWINGS

The above and other objects, features and advantages of the present invention will become more apparent from the following detailed description made with reference to the accompanying drawings. In the drawings:

FIG. 1A is a schematic cross-sectional view showing a driving mechanism for a high pressure EGR control valve and a switching valve for a high-pressure EGR cooling device, according to a first embodiment of the invention;

FIG. 1B is a schematic view showing a major portion of the driving mechanism of FIG. 1A, when viewed from a bottom (DOWN) side;

FIG. 2A is likewise a schematic cross-sectional view showing the driving mechanism in which a lock pin is inserted into an aperture 13 according to the first embodiment of the invention;

FIG. 2B is likewise a schematic view showing a major portion of the driving mechanism of FIG. 2A, when viewed from the bottom (DOWN) side;

FIG. 3 is a graph showing an opening degree (Q) of a high pressure EGR control valve with respect to rotational angle of the high pressure EGR control valve and also showing switching positions of a switching valve;

FIGS. 4A and 4B are schematic cross-sectional views showing operational positions of the high pressure EGR control valve and the switching valve, wherein FIG. 4A shows a hot EGR mode and FIG. 4B shows a cold EGR mode;

FIG. 5 is a schematic view showing a general structure for an intake and exhaust system for an engine;

FIG. 6 is a graph showing an EGR operation according to programs for controlling high pressure and/or low pressure EGR operation;

FIG. 7A is a schematic cross-sectional view showing the driving mechanism corresponding to FIG. 1A;

FIG. 7B is an enlarged cross-sectional view of a portion encircled in FIG. 7A;

FIG. 7C is an enlarged cross-sectional view showing a sliding end portion according to a second embodiment of the present invention;

FIG. 8 is a schematic cross-sectional view showing a driving mechanism according to a third embodiment of the invention;

FIG. 9 is a schematic cross-sectional view showing a driving mechanism according to a fourth embodiment of the invention; and

FIG. 10 is a schematic view showing a general structure for an intake and exhaust system for an engine of a related art.

### DETAILED DESCRIPTION OF THE PREFERRED EMBODIMENTS

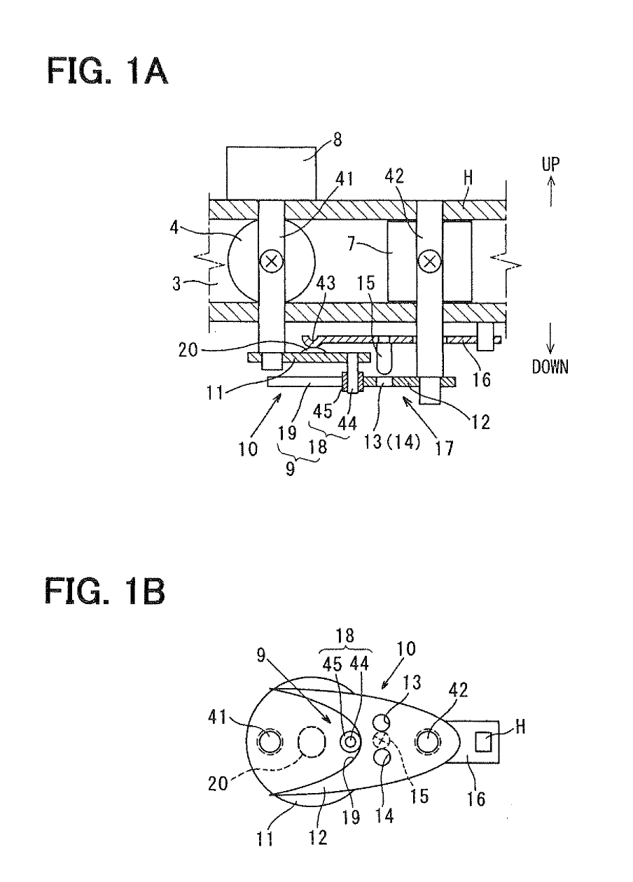

An embodiment of the present invention will be explained with reference to FIGS. 1 to 6. The same reference numerals are used for identical or similar parts through multiple embodiments.

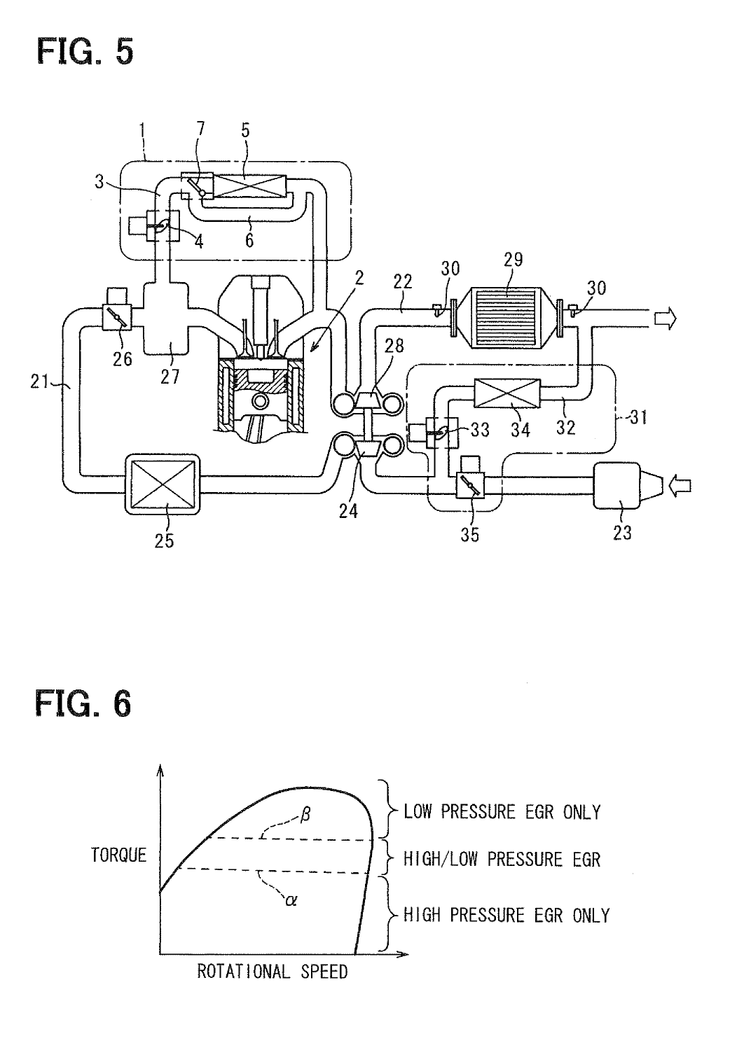

As shown in FIG. 5, a high pressure (H-P) EGR apparatus 1 is composed of a high pressure (H-P) EGR passage 3 for re-circulating a part of exhaust gas of an engine 2 into an air-intake side as EGR gas, a high pressure (H-P) EGR control valve 4 for adjusting an opening degree of the H-P EGR passage 3 so as to control flow amount of the EGR gas (EGR amount), a high pressure (H-P) EGR cooling device 5 provided in the H-P EGR passage 3 for cooling down the EGR gas which will be re-circulated into the air-intake side, a bypass passage 6 provided at intermediate portions of the H-P EGR passage 3 so that the EGR gas re-circulated to the air-intake side may bypass the H-P EGR cooling device 5, and a switching valve 7 provided in the H-P EGR passage 3 for switching over flow of the EGR gas so that the EGR gas may flow either through the H-P EGR cooling device 5 or through the bypass passage 6.

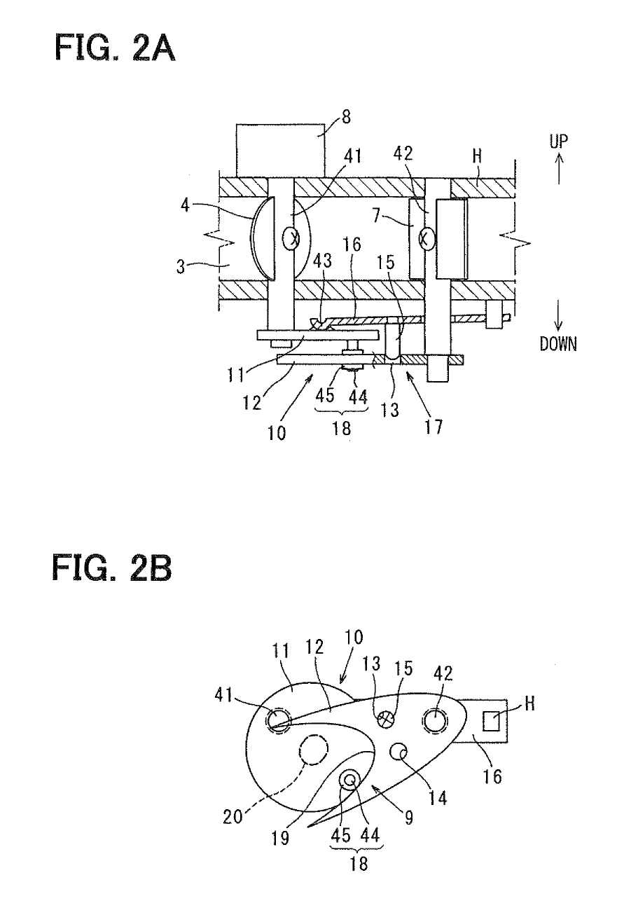

As shown in FIGS. 1A and 2A, the H-P EGR apparatus 1 has an electric actuator 8 (as an example of actuators) for driving the H-P EGR control valve 4, a converting mechanism (a converting device) 9 for converting output characteristic of the electric actuator 8, and a link device 10 for driving the switching valve 7 by means of output converted by the converting mechanism 9.

The link device 10 is composed of a power transmitting arm 11 for driving the H-P EGR control valve 4 and a cooler switching cam 12 for driving the switching valve 7 for the H-P EGR passage 3.

The link device 10 is further composed of a lock mechanism 17 having a lock pin 15 and a lever 16. The lock pin 15 will be engaged with (inserted into) an aperture 13 or 14 formed in the cooler switching cam 12 when the switching valve 7 is moved to a hot switching position or a cold switching position. In a hot EGR mode (when the switching valve 7 is moved to and held at the hot switching position), the switching valve 7 closes a main passage portion of the H-P EGR passage 3 (the passage for the H-P EGR cooling device 5) so that flow of the exhaust gas through the H-P EGR cooling device 5 is cut off. In other words, the switching valve 7 opens the bypass passage 6 so that the exhaust gas (that is, the EGR gas) bypasses the H-P EGR cooling device 5. On the other hand, in a cold EGR mode (when the switching valve 7 is moved to and held at the cold switching position), the switching valve 7 opens the main passage portion of the H-P EGR passage 3 so that the exhaust gas (EGR gas) flows through the H-P EGR cooling device 5. In other words, the switching valve 7 closes the bypass passage 6. The lever 16 biases the lock pin 15 toward the cooler switching cam 12 having the apertures 13 and 14.

The converting mechanism 9 is composed of a driving pin 18, which is provided on the power transmitting arm 11 at a distance from a rotating center thereof so that the driving pin 18 describes an arc, and a cam portion 19, which is formed at the cooler switching cam 12 at a distance from a rotating center thereof and brought in contact with the driving pin 18 so that the cooler switching cam 12 receives a driving force from the driving pin 18.

A cam profile of the cam portion 19 is formed in such a shape that the switching valve 7 is driven at a rotational speed different from that of the H-P EGR control valve 4. More exactly, in a small switching-angular range of the H-P EGR control valve 4, that is an angular range within which opening degree of the H-P EGR passage 3 is controlled around its maximum amount, the switching valve 7 is largely rotated in order that an EGR mode is switched from the hot EGR mode to the cold EGR mode, or vice versa.

In other angular ranges (than the switching-angular range), that is an angular range in which the opening degree of the H-P EGR passage 3 is controlled at an amount other than the maximum amount, the switching valve 7 is held at its hot or cold switching position so that EGR operation is carried out in the hot or cold EGR mode.

A lever-lift cam 20 is provided on the power transmitting arm 11 so that the lever 16 is lifted up within a certain angular range of the power transmitting arm 11 (which corresponds to the switching-angular range), during which the switching valve 7 is switched over from its hot switching position to the cold switching position, or vice versa. As a result, the lock pin 15 is also lifted up so that the lock pin 15 is brought out of the engagement (out of a locked condition) with the aperture 13 or 14 within such angular range.

The first embodiment will be explained more in detail. An air intake system as well as exhaust gas system of the engine 2 will be explained with reference to FIGS. 5 and 6.

The engine 2 is a diesel engine for driving a vehicle, which has an intake-air passage 21 for supplying intake air into respective cylinders and an exhaust gas passage 22 for discharging exhaust gas generated in the cylinders into the air.

The intake-air passage 21 is composed of passages formed by an intake pipe, an intake manifold and intake ports. The intake pipe is a passage member forming a part of the intake-air passage 21 from an air entering portion to the intake manifold. An air cleaner 23 is provided in the intake pipe for removing dust contained in the intake air to be supplied into the engine 2. In addition, an intake-air sensor (an air-flow sensor) for measuring intake-air amount, a compressor (an intake-air bladed wheel) 24 of a turbo-charger, an inter cooler 25 for forcibly cooling down the intake air temperature of which is increased by compressing the intake air, and a throttle valve 26 for adjusting the intake-air amount to be supplied into the cylinders and so on are likewise provided in the intake pipe. The intake manifold is an air distributing member for distributing the intake air to be supplied from the intake pipe into the respective cylinders. A surge tank 27 is provided in the intake manifold for preventing pulsation and/or interference of the intake air, which would otherwise adversely affect accuracy of the air-flow sensor. The intake ports are formed in a cylinder head of the engine 2 for supplying the intake air distributed by the intake manifold into the respective cylinders.

The exhaust gas passage 22 is composed of passages formed by exhaust ports, an exhaust manifold, and an exhaust pipe. The exhaust ports are also formed in the cylinder head of the engine 2 for discharging the exhaust gas produced in the cylinders to the exhaust manifold. The exhaust manifold is a gas collecting member for collecting exhaust gas discharged from the respective exhaust ports. And an exhaust gas turbine (an exhaust gas bladed wheel) 28 of the turbo-charger is provided at a connecting portion between an exhaust gas outlet portion of the exhaust manifold and the exhaust pipe. The exhaust pipe is a passage member for emitting the exhaust gas having passed through the exhaust gas turbine 28 into the air. A DPF (Diesel Particulate Filter) 29 is provided in the exhaust pipe for trapping particulates contained in the exhaust gas. In addition, exhaust gas temperature sensors 30 for detecting temperature of the exhaust gas at an upstream side and a downstream side of the DPF 29, a differential pressure sensor (not shown) for detecting a differential pressure between the upstream and the downstream sides of the DPF 29, and so on are provided in the exhaust pipe.

Intake valves and exhaust valves are provided in the cylinder head, in which the intake ports and the exhaust ports are formed, so that each of the intake valves opens and closes each outlet end of the intake port (each boundary portion between the intake port and an inside of the cylinder) and each of the exhaust valves likewise opens and closes each inlet end of the exhaust port (each boundary portion between the exhaust port and the inside of the cylinder).

Each cylinder of the engine 2 repeatedly carries out an intake stroke, a compression stroke, an explosion stroke, and an exhaust stroke. The intake valve is opened at a beginning of the intake stroke (when a cylinder volume is increased in accordance with a downward movement of a piston) and closed at an end of the intake stroke (when an increase of the cylinder volume is terminated as a result of ending the downward movement of the piston). As a result of the above air-intake operation of the engine 2, flow of the intake-air is generated in the intake-air passage 21, wherein the intake-air flows from the air entering portion into the cylinders of the engine 2.

In a similar manner to the above, the exhaust valve is opened at a beginning of the exhaust stroke (when the cylinder volume is decreased in accordance with the upward movement of the piston) and closed at an end of the exhaust stroke (when the decrease of the cylinder volume is terminated as a result of ending the upward movement of the piston). Therefore, flow of the exhaust gas is generated in the exhaust gas passage 22 by the above gas exhausting operation of the engine 2, wherein the exhaust gas flows from the cylinder to a gas emitting portion of the exhaust pipe.

The air-intake and exhaust gas systems of the engine 2, as shown in FIG. 5, have a low pressure (L-P) EGR apparatus 31 in addition to the H-P EGR apparatus 1, to which the present invention is applied.

The H-P EGR apparatus 1 is an exhaust gas re-circulation apparatus having the H-P EGR passage 3, which is connected at its one end to an upstream side of the exhaust gas passage 22 and at the other end to a downstream side of the intake-air passage 21, so that a part of the exhaust gas is re-circulated as EGR gas into the downstream side of the intake-air passage 21. In the H-P EGR apparatus 1, exhaust gas pressure at the upstream side of the exhaust gas passage 22 is higher than that at a downstream side thereof, while negative pressure at the downstream side of the intake-air passage 21 is larger than that at an upstream side thereof, so that a larger amount of the EGR gas can be re-circulated into the cylinders of the engine 2. In the embodiment shown in FIG. 5, the H-P EGR passage 3 is connected to the exhaust manifold for the exhaust gas passage 22 on one hand, and to the surge tank 27 for the intake-air passage 21 on the other hand.

As already explained, provided in the H-P EGR passage 3 are the H-P EGR control valve 4 for adjusting the opening degree of the H-P EGR passage 3 so as to control flow amount of the EGR gas, the H-P EGR cooling device 5 for cooling down the EGR gas which is re-circulated into the air-intake side, the bypass passage 6 through which the EGR gas to be re-circulated to the air-intake side may bypass the H-P EGR cooling device 5, and the switching valve 7 for switching over flow of the EGR gas so that the EGR gas may flow either through the H-P EGR cooling device 5 or through the bypass passage 6.

The above H-P EGR control valve 4, the H-P EGR cooling device 5, the bypass passage 6 and the switching valve 7 may be in advance assembled as a high pressure EGR module, which will be then mounted on a vehicle. The present invention should not be, however, limited to such high pressure EGR module.

The L-P EGR apparatus 31 is an exhaust gas re-circulation apparatus having a low pressure (L-P) EGR passage 32, which is connected at its one end to the downstream side of the exhaust gas passage 22 and at the other end to the upstream side of the intake-air passage 21, so that another part of the exhaust gas is also re-circulated as EGR gas into the upstream side of the intake-air passage 21.

In the L-P EGR apparatus 31, the exhaust gas pressure at the downstream side of the exhaust gas passage 22 is lower than that at the upstream side thereof, while negative pressure at the upstream side of the intake-air passage 21 is smaller than that at the downstream side thereof, so that a smaller amount of the EGR gas may be likewise re-circulated into the cylinders of the engine 2. In the embodiment shown in FIG. 5, the L-P EGR passage 32 is connected to the exhaust pipe at the downstream side of the DPF 29 on one hand, and to the intake pipe at the upstream side of the compressor 24 for the turbo-charger on the other hand.

Provided in the L-P EGR passage 32 are a low pressure (L-P) EGR control valve 33 for adjusting an opening degree of the L-P EGR passage 32 so as to control flow amount of the EGR gas, and a low pressure (L-P) EGR cooling device 34 for cooling down the EGR gas which is re-circulated into the air-intake side.

A pressure generating valve 35 is provided in the intake pipe at an upstream side of a connecting portion of the L-P EGR passage 32 to the intake pipe, so that negative pressure is generated at the connecting portion of the L-P EGR passage 32. The pressure generating valve 35 is so designed that a portion of the intake-air passage 21 (for example, around 10% of the intake-air passage) can be still opened even in a case that the pressure generating valve 35 is moved to its maximum closing position.

The above L-P EGR control valve 33, the L-P EGR cooling device 34, and the pressure generating valve 35 may be in advance assembled as a low pressure EGR module, which will be then mounted on the vehicle. The present invention should not be, however, limited to such low pressure EGR module.

Each of the H-P EGR cooling device 5 and the L-P EGR cooling device 34 is a gas cooling device of a water-cooling type, in which heat exchange is carried out between engine cooling water for the engine 2 and high-temperature EGR gas so as to cool down the high-temperature EGR gas. Therefore, each of those cooling devices 5 and 34 has a heat-exchanger for carrying out the heat exchange between the engine cooling water and the EGR gas.

Opening degrees of the H-P EGR control valve 4 and the switching valve 7 for the H-P EGR apparatus 1 as well as opening degrees of the L-P EGR control valve 33 and the pressure generating valve 35 for the L-P EGR apparatus 31 are controlled by an electronic control unit (ECU) (not shown).

The ECU is an engine control electronic device having a well known micro-computer, which is composed of CPU for carrying out control process and calculation process, a memory device (such as ROM, RAM, and so on) for storing various kinds of control programs and data, Input-Output circuits, and so on.

The ECU performs an operational control (including a fuel injection control) for the engine 2, based on the control programs stored in the memory device and various sensor signals (such as, operation signals operated by a vehicle driver, detection signals from various kinds of detection sensors, and so on). An EGR control program for carrying out operational controls for the H-P EGR apparatus 1 and the L-P EGR apparatus 31 is also stored in the memory device of the ECU.

The EGR control program includes a cooling-device switching program, according to which the switching valve 7 is operated based on a warming-up condition of the engine 2 (for example, temperature of the engine cooling water). The EGR control program further includes an EGR amount control program, according to which the opening degrees of the H-P EGR control valve 4, the L-P EGR control valve 33 as well as the opening degree of the pressure generating valve 35 are controlled based on engine rotational speed and engine load (that is, engine torque).

According to the cooling-device switching program, the switching valve 7 is operated as below:

(1) The switching valve 7 opens the bypass passage 6 and closes the passage for the H-P EGR cooling device 5, during a period from a time when an ignition switch is turned on to a time when an warming-up operation for the engine 2 will be completed. In other words, the switching valve 7 is moved to the hot switching position, during an engine operating condition in which warming-up effect by the EGR gas is required (Hot EGR mode).

(2) On the other hand, the switching valve 7 closes the bypass passage 6 and opens the passage for the H-P EGR cooling device 5, after the warming-up operation for the engine has been completed (for example, when the temperature of the engine cooling water becomes higher than a predetermined temperature). In other words, the switching valve 7 is moved to the cold switching position during such an engine operating condition in which engine output would be otherwise decreased as a result of cubic expansion of the intake air when the high-temperature EGR gas is re-circulated into the air-intake side (Cold EGR mode).

Furthermore, according to the cooling-device switching program, the switching operation of the switching valve 7 may be carried out during an engine operating condition in which fuel-cut control is carried out for the engine 2 (for example, during a vehicle decelerating condition by engine-brake operation).

An operation of the EGR apparatus will be explained with reference to FIG. 6. According to the EGR amount control program, the EGR operation is controlled as below:

(1) In a case that an engine operating condition is in a range below a dotted line “α” in FIG. 6 (namely, when the engine torque with respect to the engine rotational speed is lower than the dotted line “α”), an operation for the L-P EGR apparatus 31 is stopped so that the EGR operation is carried out only by the opening degree of the H-P EGR control valve 4 of the H-P EGR apparatus 1. More exactly, the L-P EGR passage 32 is closed by the L-P EGR control valve 33, and the opening degree of the H-P EGR control valve 4 is controlled depending on a relationship between the engine rotational speed and the engine torque.

(2) In a case that the engine operating condition is in a range between the dotted line “α” and a dotted line “β” in FIG. 6, the EGR operation is carried out by controlling both of the opening degrees of the H-P EGR control valve 4 of the H-P EGR apparatus 1 and the L-P EGR control valve 33 of the L-P EGR apparatus 31. More exactly, the opening degree of the H-P EGR control valve 4 of the H-P EGR apparatus 1 is controlled depending on the relationship between the engine rotational speed and the engine torque, while the opening degree of the L-P EGR control valve 33 as well as the pressure generating valve 35 of the L-P EGR apparatus 31 is controlled depending on the relationship between the engine rotational speed and the engine torque.

(3) In a case that the engine operating condition is in a range above the dotted line “p” in FIG. 6, the operation for the H-P EGR apparatus 1 is stopped so that the EGR operation is carried out only by the opening degree of the L-P EGR control valve 33 of the L-P EGR apparatus 31. More exactly, the H-P EGR passage 3 is closed by the H-P EGR control valve 4, and the opening degree of the L-P EGR control valve 33 as well as the pressure generating valve 35 is controlled depending on the relationship between the engine rotational speed and the engine torque.

As above, the H-P EGR apparatus 1 has the switching valve 7 for opening or closing the passage for the H-P EGR cooling device 5 in addition to the H-P EGR control valve 4 for controlling the EGR amount, the opening degree of the H-P EGR control valve 4 is controlled so as to obtain such EGR amount depending on the engine rotational speed and the engine load, and the switching valve 7 is switched to its hot or cold switching position depending on the warming-up condition of the engine 2. In other words, the H-P EGR control valve 4 and the switching valve 7 are independently operated from each other, namely they are respectively operated depending on different engine operating conditions.

As a result, in the prior art EGR apparatus, an actuator for driving the H-P EGR control valve 4 and another actuator for driving the switching valve 7 are separately required, which would result in cost-up, size-increase, and weight-increase.

The H-P EGR apparatus 1 according to the first embodiment, which overcomes the above mentioned drawbacks, will be further explained with reference to FIGS. 1 to 4, wherein “UP” and “DOWN” are indicated in FIGS. 1A and 2A only for the purpose of explaining the invention.

In addition to the structure of the H-P EGR apparatus 1 explained above, it further has the electric actuator 8 for driving the H-P EGR control valve 4 and the link device 10 for driving the switching valve 7 by converting the output characteristic of the electric actuator 8 via the converting mechanism 9.

The H-P EGR control valve 4 controls the EGR amount by changing its rotational position (the opening degree thereof), while the switching valve 7 switches over from the opening of the passage for the H-P EGR cooling device 5 to the opening of the bypass passage 6, or vice versa, by likewise changing its rotational position (the switching position). An EGR-valve supporting shaft 41, to which the H-P EGR control valve 4 is fixed, and a switching-valve supporting shaft 42, to which the switching valve 7 is fixed, are arranged in parallel to each other in a direction of UP-DOWN. The shafts 41 and 42 are rotatably supported by bearing members (not shown) in a housing H, which forms a part of the H-P EGR passage 3.

The electric actuator 8 is composed of a well known electric motor which generates rotational driving power upon receiving electric power. The electric actuator 8 is provided at an upper side of the housing H and drives to rotate the EGR-valve supporting shaft 41 as well as the switching-valve supporting shaft 42 via the link device 10. In the first embodiment, a DC motor is used as the electric motor, so that control for its rotational angle can be done.

The electric actuator 8 may be composed of solely the electric motor (namely, the EGR-valve supporting shaft 41 may be directly driven by the electric motor), or may be composed of the electric motor and a speed reduction mechanism provided between the electric motor and the EGR-valve supporting shaft 41 (for example, a mechanical reduction gear, so that rotational speed of the electric motor is reduced and such increased torque as a result of the speed reduction is transmitted to the EGR-valve supporting shaft 41).

The link device 10 is arranged at a lower side of the housing H in order to drive the switching valve 7 by converting the output characteristic of the electric actuator 8 via the converting mechanism 9. The link device 10 is composed of the power transmitting arm 11 driven by the EGR-valve supporting shaft 41 and the cooler switching cam 12 for driving the switching valve 7.

The power transmitting arm 11 is fixed to a lower end of the EGR-valve supporting shaft 41, so that the power transmitting arm 11 is rotated together with the H-P EGR control valve 4. The power transmitting arm 11 is formed in a disc shape and made of material having high wear resistance (for example, nylon resin). The power transmitting arm 11 is fixed to the EGR-valve supporting shaft 41 at a right angle thereto.

The cooler switching cam 12 is fixed to a lower end of the switching-valve supporting shaft 42, so that the cooler switching cam 12 is rotated together with the switching valve 7. The cooler switching cam 12 is formed in a semi lunar shape and made of material having high wear resistance (for example, nylon resin). The cooler switching cam 12 is fixed to the switching-valve supporting shaft 42 at a right angle thereto, in such a way that rotating ends of the cooler switching cam 12 overlap with the power transmitting arm 11 at a predetermined distance in the UP-DOWN direction, as best shown in FIG. 1A or 2A.

The link device 10 further has the lock mechanism 17, with which the switching valve 7 is locked to (held at) either the hot or the cold switching position.

The lock mechanism 17 is composed of the apertures 13 and 14 (a cold-lock aperture 13 and a hot-lock aperture 14, as explained below) formed in the cooler switching cam 12, the lock pin 15 which will be engaged with (inserted into) the aperture 13 or 14 depending on a rotational position of the cooler switching cam 12, and the lever 16 for biasing the lock pin 15 toward the cooler switching cam 12 having the apertures 13 and 14.

Each of the apertures 13 and 14 formed in the cooler switching cam 12 respectively corresponds to the cold-lock aperture 13 for locking the switching valve 7 at the cold switching position and to the hot-lock aperture 14 for locking the switching valve 7 at the hot switching position.

When the cooler switching cam 12 is rotated to a hot EGR switching side (in a clockwise direction in FIG. 1B or 2B) and the lock pin 15 is engaged with the hot-lock aperture 14, the switching valve 7 is locked to the hot switching position. On the other hand, when the cooler switching cam 12 is rotated to a cold EGR switching side (in an anti-clockwise direction in FIG. 1B or 2B) and the lock pin 15 is engaged with the cold-lock aperture 13, the switching valve 7 is locked to the cold switching position, as shown in FIG. 2B.

The lever 16 is made of a blade spring being capable of elastic deformation, and its longitudinal direction coincides with a line connecting a rotational center of the EGR-valve supporting shaft 41 with a rotational center of the switching-valve supporting shaft 42. More exactly, the lever 16 extends in a direction from the switching-valve supporting shaft 42 to the EGR-valve supporting shaft 41.

The lock pin 15, which will be engaged with the aperture 13 or 14 formed in the cooler switching can 12, is fixed to an intermediate portion of the lever 16. A sliding end portion 43 is formed at a forward end of the lever 16, wherein the sliding end portion 43 is protruded toward an upper surface of the power transmitting arm 11 so that it is in contact with the upper surface and slides thereon.

The other end (right-hand end) of the lever 16 is fixed to the housing H, so that the biasing force is generated at the lever 16 for downwardly biasing the lock pin 15 (toward the apertures 13 and 14) as well as the sliding end portion 43 (toward the upper surface of the power transmitting arm 11).

The lever 16 is so designed that the biasing force is slightly applied to the lock pin 15 for biasing the lock pin 15 in the downward direction even after the lock pin 15 is engaged with (inserted into) one of the apertures 13 and 14 (in the locked condition for the hot or cold EGR modes). As a result, a bumpy situation for the lock mechanism 17 can be avoided. In addition, the switching valve 7 may be prevented from being vibrated, even when abnormal high pressure pulsation may be generated in the H-P EGR passage 3, because the switching valve 7 is firmly locked to its locked condition (that is, the hot or cold switching position for the hot or cold EGR mode).

The converting mechanism 19 for converting the output characteristic of the electric actuator 8 is composed of the driving pin 18 provided on the power transmitting arm 11 at a distance from the rotational center thereof and the cam portion 19 formed on the cooler switching cam 12 at a distance from the rotational center thereof, wherein the cam portion 19 receives the driving force from the driving pin 18.

The driving pin 18 is composed of a shaft 44 attached to the power transmitting arm 11 at a rotating end thereof and extending in the downward direction, and a roller 45 rotatably attached to the shaft 44 for applying the rotational torque of the power transmitting arm 11 to the cam portion 19. The roller 45 is one of examples for absorbing difference of rotational speeds. The shaft 44 may be integrally formed with (or separately formed from but attached to) the power transmitting arm 11.

An outer periphery of the roller 45 may be formed in a barrel shape, so that an intermediate portion is swollen and both side portions are reduced. As a result, even in a case that the cooler switching cam 12 may be slightly inclined relative to the power transmitting arm 11, the barrel shaped roller 45 may absorb such inclination so that the roller 45 is stably in contact with the cam portion 19.

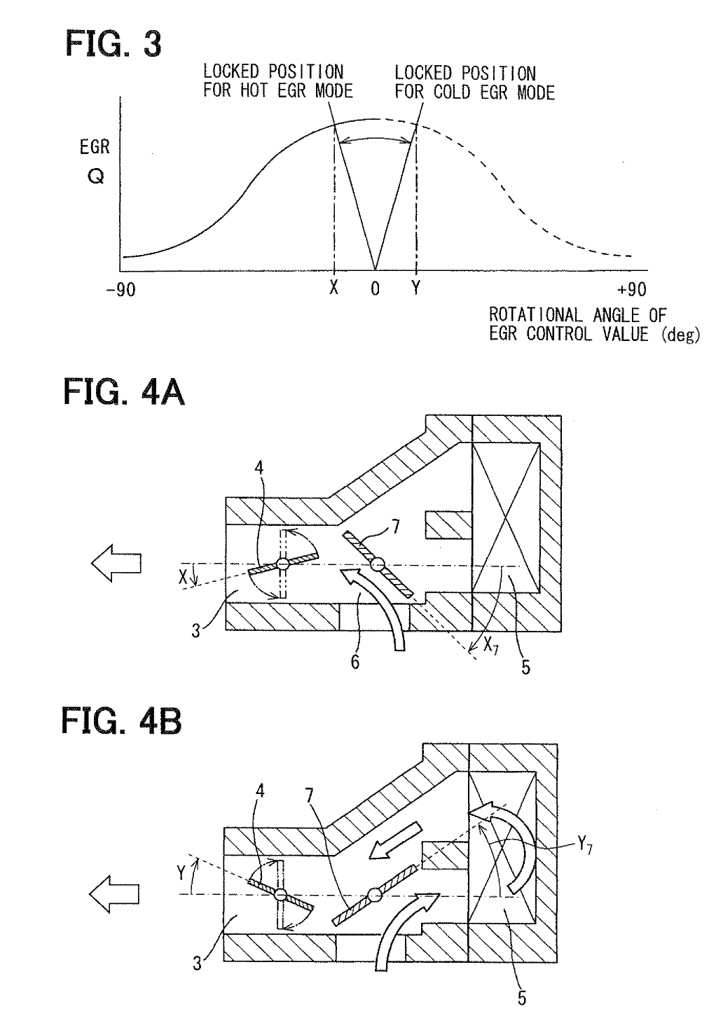

The cam profile of the cam portion 19, which receives the driving force from the driving pin 18, is formed in the following arc shape. When the H-P EGR control valve 4 is rotated in the small switching-angular range, that is the angular range between X and Y degrees shown in FIGS. 3 and 4, the H-P EGR passage 3 is opened at its maximum opening degree, while the switching valve 7 is largely rotated (by an angle of X7 or Y7 as indicated in FIG. 4A or 45) so that the switching valve 7 is moved to its hot or cold switching position.

Furthermore, according to the cam profile of the cam portion 19, in the other angular range than the above small switching-angular range (X-Y degrees), the switching valve 7 is held in its locked condition for the hot or cold switching position.

The lever-lift cam 20 is provided on the upper surface of the power transmitting arm 11 at its center, so that the lever 16 is lifted up within a certain angular range of the power transmitting arm 11 (that is, the X-Y angular range shown in FIGS. 3 and 4). As a result, the lock pin 15 is brought out of the engagement with the hot-lock or the cold-lock aperture 13 or 14.

### [Operation for Hot-Control of the EGR Amount (Hot EGR Mode)]

During the warming-up operation of the engine 2 (when the ignition switch is turned on and the temperature of the engine cooling water has not yet reached at a predetermined value), the switching valve 7 closes the passage for the H-P EGR cooling device 5 and opens the bypass passage 6 in order that the part of the exhaust gas of high temperature is re-circulated into the air-intake side. The H-P EGR apparatus 1 is operated as below:

(1) The ECU determines whether the switching valve 7 is held at the hot switching position (in which the passage for H-P EGR cooling device 5 is closed, while the bypass passage 6 is opened, as shown in FIG. 4A), or whether the switching valve 7 is held at the cold switching position (namely, whether the passage for H-P EGR cooling device 5 is opened and the bypass passage 6 is closed, as shown in FIG. 4B).

(2) When the ECU determines that the switching valve 7 is held at the cold switching position (FIG. 4B), the ECU switches over the position of the switching valve 7 from the cold switching position to the hot switching position (FIG. 4A) during the fuel-cut engine operation (that is, the engine operation in which fuel injection into the engine 2 is cut off).

More exactly, when the ECU determines that the opening degree of the H-P EGR control valve 4 is larger than the rotational angle

Y degree shown in FIG. 3 and FIG. 4B, the H-P EGR control valve 4 is moved to its maximum valve-opening position (that is, the angular position between X and Y degrees) by the electric actuator 8 during the fuel-cut engine operation, so that the lock pin 15 of the lock mechanism 17 is released from the locked position for the cold switching position (the lock pin 15 is released from the cold-lock aperture 13), as shown in FIGS. 1A and 1B. TheH-P EGR control valve 4 is further rotated from the angular position of Y degree (FIG. 4B) to the angular position of X degree (FIG. 4A). Together with the rotation of the H-P EGR control valve 4 in the small switching-angular range (from Y to X degree), the switching valve 7 is largely rotated (from Y7 to X7 degree) so that the switching valve 7 is switched from the cold switching position to the hot switching position (FIG. 4A). When the H-P EGR control valve 4 is moved to the X-degree position (FIG. 4A), the lock pin 15 is brought into engagement with the hot-lock aperture 14, so that the switching valve 7 is locked to the hot-lock position. As a result, the hot-switching condition shown in FIG. 4A is achieved.

(3) When the switching valve 7 is switched to the hot switching position, the EGR amount is controlled by rotating the H-P EGR control valve 4 in an angular range (between −90 and X degree) for hot EGR control which is smaller than the angular position of X degree, as shown in FIGS. 3 and 4A. So long as the H-P EGR control valve 4 is rotated in the angular range (between −90 and X degree) for the hot EGR control, the switching valve 7 is held at its locked condition for the hot switching position due to the cam profile of the cam portion 19. Accordingly, even in the case that the locked condition of the lock mechanism 17 may be unintentionally released owing to un-expected situations, the switching valve 7 can be held at its locked condition for the hot switching position and the EGR amount can be controlled by the rotation of the H-P EGR control valve

### [Operation for Cold-Control of the EGR Amount (Cold EGR Mode)]

When the warming-up operation for the engine 2 is completed (when the ignition switch is turned on and the temperature of the engine cooling water has reached at the predetermined value), the bypass passage 6 is closed in order to prevent a possible decrease of engine output due to the EGR gas of high temperature, and the part of the exhaust gas of high temperature is cooled down by the H-P EGR cooling device 5 and then re-circulated into the air-intake side. The H-P EGR apparatus 1 is operated as below:

(1) At first, the ECU determines whether the switching valve 7 is held at the hot switching position (FIG. 4A) or at the cold switching position (FIG. 4B).

(2) When the ECU determines that the switching valve 7 is held at the hot switching position (FIG. 4A), the ECU switches over the position of the switching valve 7 from the hot switching position to the cold switching position (FIG. 4B) during the fuel-cut engine operation.

More exactly, when the ECU determines that the opening degree of the H-P EGR control valve 4 is smaller than the rotational angle X degree (between −90 and X degree) shown in FIG. 3 and FIG. 4A, the H-P EGR control valve 4 is moved to its maximum valve-opening position (that is, the angular position between X and Y degrees) by the electric actuator 8 during the fuel-cut engine operation, so that the lock pin 15 of the lock mechanism 17 is released from the locked position for the hot switching position (the lock pin 15 is released from the hot-lock aperture 14), as shown in FIGS. 1A and 1B. The H-P EGR control valve 4 is further rotated from the angular position of X degree (FIG. 4A) to the angular position of Y degree (FIG. 4B). Together with the rotation of the H-P EGR control valve 4 in the small switching-angular range (from X to Y degree), the switching valve 7 is largely rotated (from X7 to Y7 degree) so that the switching valve 7 is switched from the hot switching position to the cold switching position (FIG. 4B). When the H-P EGR control valve 4 is moved to the Y-degree position, the lock pin 15 is brought into engagement with the cold-lock aperture 13, as shown in FIGS. 2A and 2B, so that the switching valve 7 is locked to the cold-lock position. As a result, the cold-switching condition shown in FIG. 4B is achieved.

(3) When the switching valve 7 is switched to the cold switching position, the EGR amount is controlled by rotating the H-P EGR control valve 4 in an angular range (between Y and +90 degree) for cold EGR control which is larger than the angular position of Y degree, as shown in FIGS. 3 and 4B.

So long as the H-P EGR control valve 4 is rotated in the angular range (between Y and +90 degree) for the cold EGR control, the switching valve 7 is held at its locked condition for the cold switching position due to the cam profile of the cam portion 19. Accordingly, even in the case that the locked condition of the lock mechanism 17 may be unintentionally released owing to un-expected situations, the switching valve 7 can be likewise held at its locked condition for the cold switching position and the EGR amount can be controlled by the rotation of the H-P EGR control valve 4.

According to the above H-P EGR apparatus 1 of the first embodiment, it is possible with one electric actuator 8,
(a) to change the switching position of the switching valve 7 from the hot to the cold switching position, or vice versa, and
(b) to control the EGR amount by moving (rotating) the H-P EGR control valve 4, while keeping the switching valve 7 at its hot or cold switching position.

In other words, it is possible with one electric actuator 8 to control both of the H-P EGR control valve 4 and the switching valve 7, and to meet both of the characteristic feature required for the H-P EGR control valve 4 and the characteristic feature required for the switching valve 7.

Accordingly, it is possible to suppress a possible increase of the cost for the H-P EGR apparatus 1 and also to realize a small-sized and light-weight EGR apparatus.

The H-P EGR apparatus 1 according to the first embodiment further has the following advantages.

According to the H-P EGR apparatus 1, the switching valve 7 is largely rotated by means of the cam profile of the cam portion 19 with respect to a small-angle rotation of the H-P EGR control valve 4. As a result, the link device 10 having the converting mechanism 9 can be reduced in its size, resulting in the small-sized H-P EGR apparatus 1.

According to the H-P EGR apparatus 1, the EGR-valve supporting shaft 41 and the switching-valve supporting shaft 42 are arranged in parallel to each other, and the power transmitting arm 11 and the cooler switching cam 12 are respectively fixed to the EGR-valve supporting shaft 41 and the switching-valve supporting shaft 42 at right angle.

As a result, the structure of the link device 10 having the converting mechanism 9 can be made in a simpler form, and it is easier to assemble and/or inspect for maintaining the reliable operation of the link device 10.

Furthermore, according to the above H-P EGR apparatus 1, the roller 45 is rotatably arranged at the driving pin 18 for transmitting the driving torque from the power transmitting arm 11 to the cam portion 19, and the outer periphery of the roller 45 is formed in the barrel shape.

As a result, even in the case that the cooler switching cam 12 may be slightly inclined relative to the power transmitting arm 11, the barrel shaped roller 45 may absorb such inclination so that the roller 45 is stably in contact with the cam portion 19.

The H-P EGR apparatus 1 according to the first embodiment has the lock mechanism 17, by which the switching valve 7 is locked to its hot or cold switching position.

As a result, the switching valve 7 may be prevented from being vibrated, even when abnormal high pressure pulsation may be generated in the H-P EGR passage 3.

### Second Embodiment

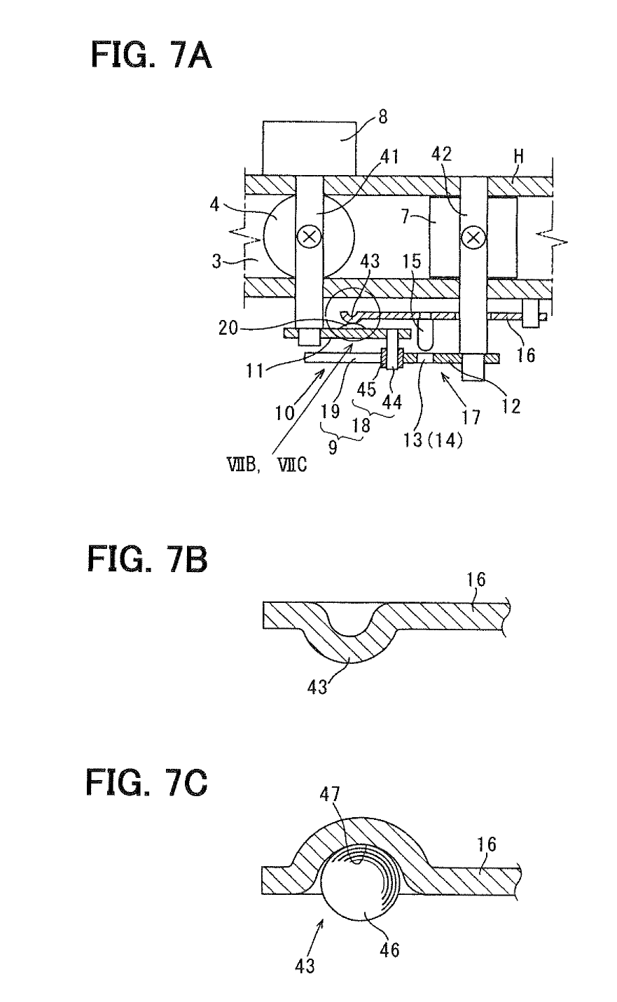

A second embodiment of the invention will be explained with reference to FIGS. 7A to 7C. In the drawing, the same reference numerals are used to the same or similar components and/or portions of the first embodiment.

FIG. 7A corresponds to FIG. 1A and a portion encircled in FIG. 7A is shown in FIG. 7B in an enlarged scale. As already explained, the sliding end portion 43 is integrally formed with the lever 16 according to the first embodiment. More exactly, the sliding end portion 43 is formed at the forward end of the lever 16 in such a way that it is formed in a hemispherical protrusion protruding in the downward direction toward the power transmitting arm 11.

According to the second embodiment, as shown in FIG. 7C, a ball 46 is used as the sliding end portion 43. More exactly, a hemispherical projection 47 is formed at the forward end of the lever 16, which is projected in the upward direction (in the direction opposite to the power transmitting arm 11), and the ball 46 is rotatably arranged in an inside of the projection 47 so that the ball 46 forms the sliding end portion 43.

As a result, contact resistance between the power transmitting arm 11 and the sliding end portion 43 can be made smaller to thereby suppress wear of the power transmitting arm 11.

### Third Embodiment

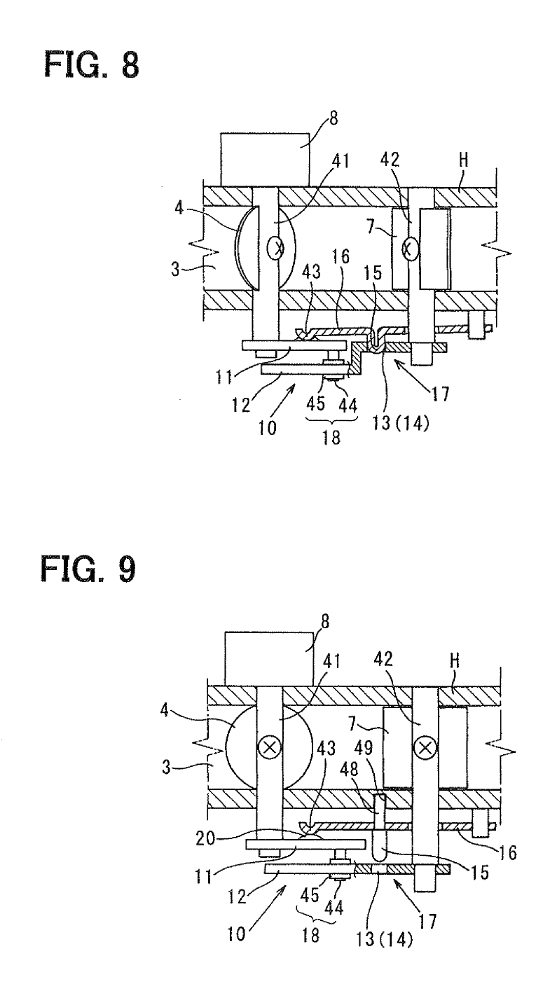

A third embodiment of the invention will be explained with reference to FIG. 8.

According to the first embodiment, the lock pin 15 is formed as a separate member and fixed to the lever 16.

According to the third embodiment, the lock pin 15 is integrally formed with the lever 16. More exactly, according to the third embodiment, the lever 16 is made of the blade spring and an intermediate portion thereof is bent to form the lock pin 15, as shown in FIG. 8.

In addition, the cooler switching cam 12 is so bent that the apertures 13 and 14 are located closer to the lock pin 15.

### Fourth Embodiment

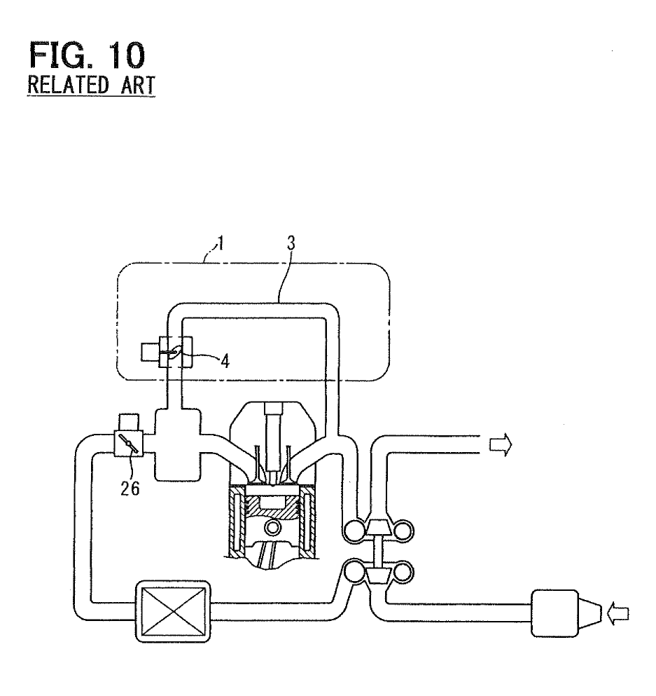

A fourth embodiment of the invention will be explained with reference to FIG. 9.

According to the first embodiment, the lock pin 15 is fixed to the lever 16 so that the lock pin 15 extends only in the downward direction.

According to the fourth embodiment, a guide shaft 48 extending in the upward direction is provided to the lock pin 15 extending in the downward direction. A guide hole 49 is formed at the housing H, so that the guide shaft 48 is slidably inserted into the guide hole 49.

As a result that the guide shaft 48 is slidably inserted into the guide hole 49 formed in the housing H, a lateral movement of the lock pin 15 can be prevented so that the switching valve 7 can be firmly held at its locked position.

Accordingly, the switching valve 7 may be prevented from being vibrated even when abnormal high pressure pulsation may be generated in the H-P EGR passage 3.

In the above embodiments, the present invention is applied to the H-P EGR apparatus 1, which is combined with the L-P EGR apparatus 31. However, the present invention may be applied to the H-P EGR apparatus 1 having no L-P EGR apparatus.

In the above embodiments, the roller 45 is used as one of examples for absorbing difference of rotational speeds. However, such a ball bearing may be used, wherein an outer race thereof may absorb an inclination of the cam portion 19 (a relative inclination between the power transmitting arm 11 and the cooler switching cam 12).

What is claimed is:

1. A high pressure EGR apparatus for an engine comprising:
a high pressure EGR passage for re-circulating a part of exhaust gas from the engine into an air-intake side of the engine as EGR gas;
a high pressure EGR control valve provided in the high pressure EGR passage for controlling EGR gas amount by adjusting an opening degree of the high pressure EGR control valve;
a high pressure EGR cooling device provided in a passage portion of the high pressure EGR passage for cooling down the EGR gas to be re-circulated into the air-intake side;
a bypass passage provided to the high pressure EGR passage in such a manner that the EGR gas to be re-circulated into the air-intake side bypasses the high pressure EGR cooling device;
a switching valve provided in the high pressure EGR passage for switching over an EGR gas flow so that the EGR gas flows either through the high pressure EGR cooling device or through the bypass passage;
an actuator for driving the high pressure EGR control valve; and
a link device having a converting mechanism for converting an output characteristic of the actuator, wherein the link device drives the switching valve by an output converted through the converting mechanism.

2. The high pressure EGR apparatus according to the claim 1, wherein
the high pressure EGR control valve controls the EGR amount by changing its rotational angle,
the switching valve switches over the EGR gas flow by changing its rotational angle, so that the EGR gas flows either through the high pressure EGR cooling device or through the bypass passage, and
the converting mechanism drives to rotate the switching valve in accordance with the rotation of the high pressure EGR control valve, so that the rotational angle of the switching valve is moved from its hot switching position to cold switching position, or vice versa, in order to switch over the EGR gas flow, wherein a movement of the rotational angle for the switching valve is larger than that of the high pressure EGR control valve.

3. The high pressure EGR apparatus according to the claim 2, wherein
the link device comprises a power transmitting arm rotatable together with the high pressure EGR control valve and a cooler switching cam rotatable together with the switching valve, wherein the power transmitting arm and the cooler switching cam are operatively linked with each other by means of the converting mechanism, and
the converting mechanism comprises a driving pin provided on the power transmitting arm at a distance from a rotating center thereof, and a cam portion formed in the cooler switching cam at a distance from a rotating center thereof, wherein the driving pin describes an arc and the cam portion receives from the driving pin a driving force in order to rotate the switching valve.

4. The high pressure EGR apparatus according to the claim 3, wherein
valve supporting shafts for the high pressure EGR control valve and the switching valve are arranged in parallel to each other, and
the power transmitting arm and the cooler switching cam are respectively arranged at right angle to the valve supporting shafts for the high pressure EGR control valve and the switching valve.

5. The high pressure EGR apparatus according to the claim 3, wherein
the driving pin has a rotatable member for absorbing differences of rotational speeds, the rotatable member being rotatably supported by the power transmitting arm 11 and applying the driving force to the cam portion, and
the rotatable member is composed of a roller having an outer periphery, which is formed in a barrel shape so that an intermediate portion thereof is swollen and both side portions thereof are reduced, or the rotatable member is composed of a ball bearing having an outer race which absorbs a relative inclination between the power transmitting arm and the cooler switching cam.

6. The high pressure EGR apparatus according to the claim 1, wherein
the link device has a lock mechanism for keeping the switching valve at its locked condition of a hot or a cold switching position, and
the link device has a lock-releasing device so that the locked condition is released when the switching valve is switched from its locked condition of either one of the hot and cold switching positions to the other locked condition of the other switching position.

7. The high pressure EGR apparatus according to the claim 1, wherein
the link device comprises a power transmitting arm being driven by the high pressure EGR control valve and a cooler switching cam for driving the switching valve,
the link device comprises a lock mechanism having a lock pin and a lever, wherein the lock pin will be engaged with one of apertures formed in the cooler switching cam when the switching valve is moved to either its hot switching position for opening the bypass passage or its cold switching position for opening the passage portion for the high pressure EGR cooling device, and the lever biases the lock pin toward the cooler switching cam having the apertures,
the converting mechanism comprises a driving pin provided on the power transmitting arm at a distance from a rotating center thereof, and a cam portion formed in the cooler switching cam at a distance from a rotating center thereof, wherein the driving pin describes an arc and the cam portion receives from the driving pin a driving force in order to rotate the switching valve,
a cam profile of the cam portion has such a shape that the switching valve is largely rotated when the high pressure EGR control valve is rotated in a predetermined switching-angular range so that a rotational position of the switching valve is changed from its hot or cold switching position to the other switching position, wherein the high pressure EGR control valve opens the high pressure EGR passage to its maximum amount when the high pressure EGR control valve is in the small switching-angular range,
the switching valve is held by the cam profile at its hot or cold switching position when the high pressure EGR control valve is rotated in the other angular range than the predetermined switching-angular range, and
the power transmitting arm has a lever-lift cam for lifting up the lever so as to bring the lock pin out of the engagement with the aperture in the predetermined switching-angular range, in which the rotational position of the switching valve is changed from its hot or cold switching position to the other switching position.
